(19) United States
(12) Patent Application Publication
(10) Pub. No.: US 2026/0121961 A1
(43) Pub. Date: Apr. 30, 2026

(54) TELECOMMUNICATIONS SYSTEM

(71) Applicant: GM GLOBAL TECHNOLOGY OPERATIONS LLC, Detroit, MI (US)

(72) Inventors: Chuan Li, Troy, MI (US); Fan Bai, Ann Arbor, MI (US); Sheng Liu, Novi, MI (US)

(73) Assignee: GM GLOBAL TECHNOLOGY OPERATIONS LLC, Detroit, MI (US)

(21) Appl. No.: 18/931,177

(22) Filed: Oct. 30, 2024

(51) Int. Cl. H04L 43/0894; H04L 43/04; H04L 43/062; H04L 43/12

(52) U.S. Cl. CPC H04L 43/0894; H04L 43/04; H04L 43/062; H04L 43/12

(57) ABSTRACT

A telecommunications method includes acquiring communication traffic metadata from one or more communication applications in a vehicle. The method additionally includes identifying an achievable communication data rate for a first communication option along a projected vehicle route. Further, the method includes, if all of the following are true, using the first communication option for communication with the communication applications: baseline traffic of the communication applications will be supported by the first communication option; the data rate time gaps during which the achievable communication data rate will be less than a required communication data rate for the communication applications will be less than a maximum latency time; the data communication deficits during which the achievable communication data rate will be less than the required communication data rate will be recovered by use of the first communication option at or before the maximum latency time.

### INTRODUCTION

This disclosure is in the field of telecommunications systems.

In a telecommunications system, user equipment such as a mobile phone or a vehicle telecommunication control unit may have multiple communication options. A system that selects a communication option that will provide favorable data communication performance will be advantageous.

### SUMMARY

A telecommunications method includes, through one or more controllers, acquiring communication traffic metadata from one or more communication applications in a vehicle. The method additionally includes identifying an achievable communication data rate for a first communication option along a projected driving route of the vehicle. Further, the method includes, if all of the following are true, using the first communication option for communication with the one or more communication applications: baseline communications traffic of the one or more communication applications will be supported by the first communication option; all or substantially all data rate time gaps during which the achievable communication data rate will be less than a required communication data rate for the one or more communication applications will be less than a maximum latency time; and all or substantially all data communication deficits during which the achievable communication data rate will be less than the required communication data rate will be recovered by use of the first communication option at or before the maximum latency time.

In the telecommunications method, the first communication option may include cellular communications. The cellular communications may include fifth generation (“5G”) cellular telecommunications.

The telecommunications method may include performing a gap test, where for a plurality of locations along the projected driving route when the achievable communication data rate will be less than the required communication data rate, confirming that any accumulated data communication deficits will be recovered within the maximum latency time.

At least one of the communication applications may be self-describing. At least a portion of the metadata may be acquired from non-self-describing communication applications. The method may include sampling data traffic with at least one of the communication applications to infer communication profiles, baseline traffic, and allowable latency for at least one of the communication applications. At least a portion of the metadata may be acquired by sampling Transmission Control Protocol/Internet Protocol (“TCP/IP”) layer communication traffic with at least one of the communication applications.

A second telecommunications method includes, through one or more controllers, acquiring communication traffic metadata from one or more communication applications in a vehicle. The method also includes identifying a first achievable communication data rate for a first cellular communication option along a projected driving route of the vehicle. Additionally, the method includes identifying a second achievable communication data rate for a second cellular communication option along the projected driving route of the vehicle. Further, the method includes confirming that the first cellular communication option can support a baseline communications traffic of the one or more communication applications along the projected driving route. Yet further, the method includes confirming that the second cellular communication option can support the baseline communications traffic along the projected driving route. Additionally, the method includes confirming that with use of the first cellular communication option, all or substantially all data rate time gaps during which the first achievable communication data rate will be less than a required communication data rate for the one or more communication applications will be less than a maximum latency time along the projected driving route. Further yet, the method includes confirming that with use of the second communication option, all or substantially all data rate time gaps during which the second achievable communication data rate will be less than the required communication data rate will be less than the maximum latency time along the projected driving route. Additionally, the method involves confirming that with use of the first cellular communication option, all or substantially all first data communication deficits during which the first achievable communication data rate will be less than the required communication data rate will be recovered by use of the first communication option at or before a maximum latency time. Further, the method involves confirming that with use of the second cellular communication option, all or substantially all second data communication deficits during which the second achievable communication data rate will be less than the required communication data rate will be recovered by use of the second communication option at or before the maximum latency time. Further, the method includes, if by use of the first cellular communication option, all or substantially all of the first data communication deficits will be recovered more quickly than the second data communication deficits will be recovered by use of the second cellular communication option, using the first cellular communication option for communication by the communication applications along the projected driving route.

The at least one communication application may be self-describing. Further, the at least one communication application may communicate using variable bitrate traffic and may provide information that characterizes the variable bitrate traffic.

Additionally, at least a portion of the metadata may be acquired from non-self-describing communication applications. Further, at least a portion of the metadata may be acquired by sampling TCP/IP layer communications traffic with at least one of the communication applications.

A vehicle includes a telecommunications controller, the telecommunications controller programmed with and operable to execute the following instructions: acquire communication traffic metadata from one or more communication applications in the vehicle; identify an achievable communication data rate for a first communication option along a projected driving route of the vehicle; and if all of the following are true, use the first communication option for communication with the one or more communication applications: baseline communications traffic of the one or more communication applications will be supported by the first communication option; all or substantially all data rate time gaps during which the achievable communication data rate will be less than a required communication data rate for the one or more communication applications will be less than a maximum latency time; and all or substantially all data communication deficits during which the achievable communication data rate will be less than the required communication data rate will be recovered by using the first communication option at or before a maximum latency time.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 illustrates a telecommunications system.

FIG. 2 is a graph showing achievable data communication rate versus location of user equipment.

FIG. 3 is an overview of a method for selecting a communication option.

FIG. 4 includes several curves illustrating data traffic in a telecommunications system.

FIG. 5 illustrates a “gap test” for determining whether a data communication option can compensate for a data communication deficit.

FIG. 5A further illustrates the gap test.

FIG. 6 illustrates baseline and fluctuating data traffic for user equipment in a telecommunications system.

FIG. 7 illustrates application data traffic and achievable data rate in a telecommunications system.

FIG. 8 illustrates application data traffic and achievable data rate in the case of a lag or deficit in data communication capacity.

### DETAILED DESCRIPTION

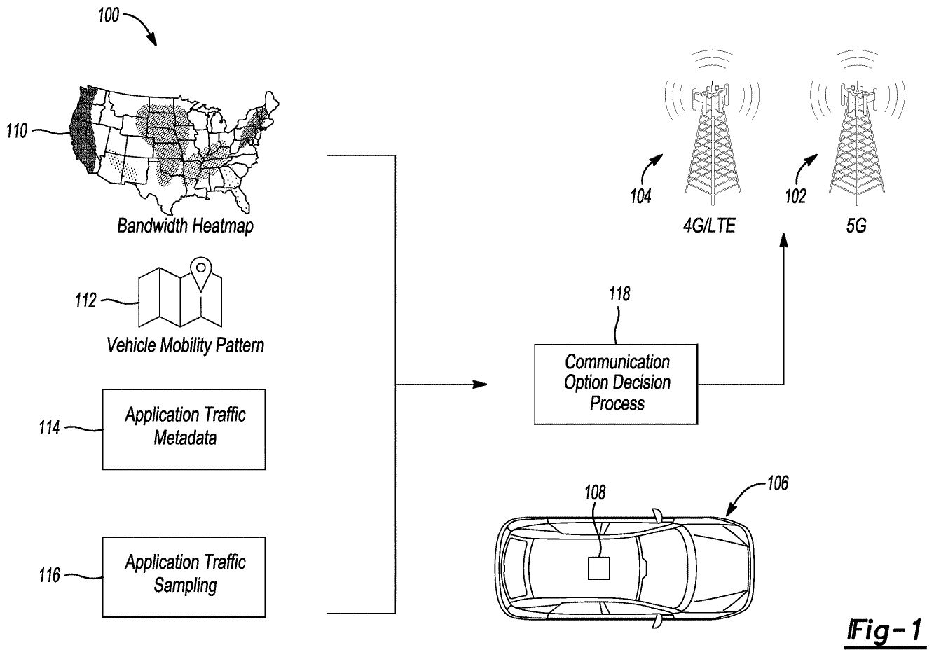

Referring first to FIG. 1, a telecommunications system 100 is illustrated. Telecommunications system 100 may include multiple communication technologies. The multiple communication technologies may include fifth-generation (“5G”) cellular technology, which may also be referred to as new radio (“NR”) technology. The multiple communication technologies may also include fourth-generation long-term evolution (“4G LTE”) cellular technology.

Telecommunications system 100 may include one or more 5G base stations 102. Base stations 102 may be included in cellular communications towers that also contain appropriate antennas to facilitate the cellular communications. Base stations 102 may manage or assist in managing 5G communications with user equipment that communicates via telecommunications system 100.

Telecommunications system 100 may also include one or more 4G LTE base stations 104. 4G LTE base stations 104 may be included in cellular communications towers that also contain appropriate antennas to facilitate the cellular communications. 4G LTE base stations 104 may manage or assist in managing 4G LTE communications with user equipment that communicates via telecommunications system 100.

Some base stations, such as base station 102 or base station 104, may be in cellular networks of multiple technologies. For instance, 5G base station 102 may also be a base station that manages 4G LTE communications. Likewise, 4G base station 104 may also be a base station that manages 5G communications.

Also illustrated in FIG. 1 is a vehicle 106. Vehicle 106 may be any type of vehicle, such as (without limitation) a car, truck, van, sport-utility vehicle, motorcycle, boat, or airplane. Vehicle 106 may have installed therein a telecommunications control unit (“TCU”) 108, through which vehicle 106 may communicate via cellular telecommunications. TCU 108 may generically be referred to as user equipment. Other types of user equipment that may communicate via cellular telecommunications include cellular handsets (e.g., cellular telephones, cellular smartphones) and other types of cellular-capable devices (e.g., smartwatches, laptop computers, tablet computers, and the like).

Given the nature of cellular networks, a cellular network may have numerous base stations. For instance, a 5G cellular network will in general have multiple 5G base stations. Likewise, a 4G LTE cellular network will in general have multiple 4G LTE base stations. When connecting with a cellular network, user equipment may have the option of communicating via networks of multiple alternative technologies (e.g., 5G or 4G LTE) as well as communicating via alternative base stations within a network (e.g., one of multiple base stations in a 5G network or one of multiple base stations in a 4G LTE network).

Alternate communications technologies within 5G may also include 5G sub-6 gigahertz (“5G sub-6”), which may operate at a frequency of below six gigahertz, and 5G millimeter wave (“5G mmWave”), which may operate at a higher frequency, such as greater than 30 gigahertz.

As referred to in this disclosure, a “wireless communication option,” “cellular communication option,” or simply a “communication option” may include the option to communicate via one of a number of different communication technologies, such as 4G LTE or 5G (and within 5G, sub-6 or mmWave). A communication option may also include the option to communicate via one of a number of base stations that operate within a communication technology.

TCU 108 may access a bandwidth heatmap 110 to understand the maximum data rate that may be available/achievable over a planned driving route 112 or vehicle mobility pattern of vehicle 106. That heatmap may be populated via “crowd-sourced” data that comes from numerous other vehicles that have driven on or near the planned driving route 112 of vehicle 106 and whose cellular communications have identified the maximum available/achievable data rate in the geographic positions along that route. The inventors have recognized that the available/achievable data rate may be highly dependent upon geographic location of vehicle 106. Further, in some geographic locations, a first communication technology may provide a higher achievable communications data rate than another communication technology, while in other geographic locations, the other communication technology may provide higher achievable communications data rate than the first communication technology.

TCU 108 may next, at block 114, consult application traffic metadata from one or more cellular applications that communicate via TCU 108. This may be referred to as a “white box” approach, or the cellular applications may be referred to as “self describing,” wherein substantial data to characterize the communication of the one or more cellular applications may be available.

TCU 108 may also, or alternatively, at block 116, sample the communications traffic from the one or more cellular applications that communicate via TCU 108. This may be for cellular applications that are not “self describing”. Then, a communication option decision process 118 may take place. The result may be connection of TCU 108 to a 5G network or to a 4G LTE network. The result may also be connection of TCU 108 to a particular base station among several potential base stations in a 5G network or in a 4G LTE network.

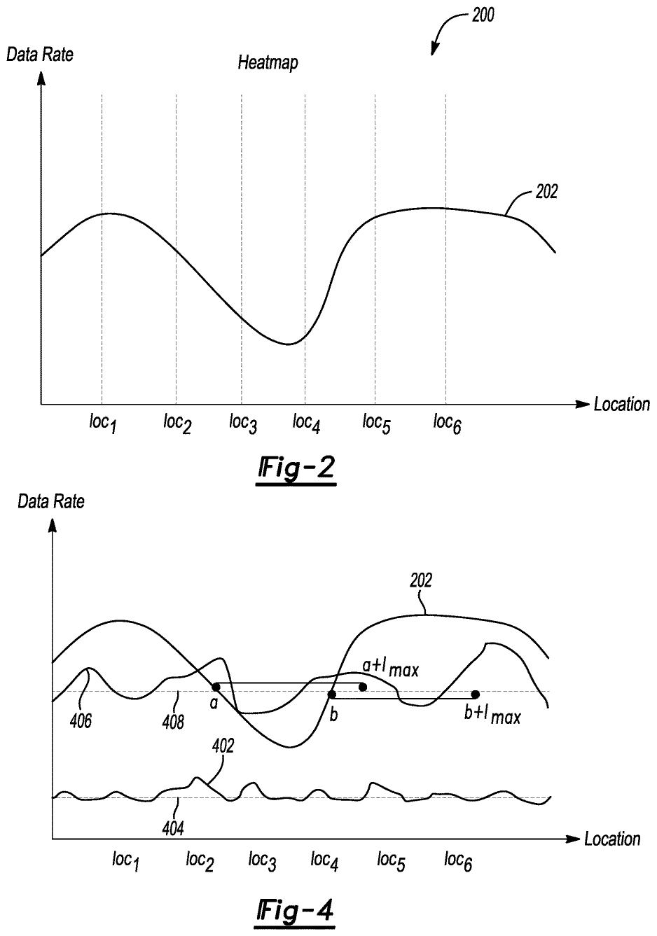

Refer additionally to FIG. 2. There, a graph 200 showing the achievable/available data rate of a telecommunications network over the planned driving route 112 of vehicle 106 is shown. The x-axis of graph 200 is locations along the planned driving route 112 of vehicle 106. The y-axis of graph 200 is the achievable/available data rate. Curve 202, then, illustrates the achievable/available data rate along the planned driving route 112 of vehicle 106. Curve 202 provides a “lookahead” opportunity to adjust the operation of TCU 108 to accommodate and take advantage of data rate available along planned driving route 112.

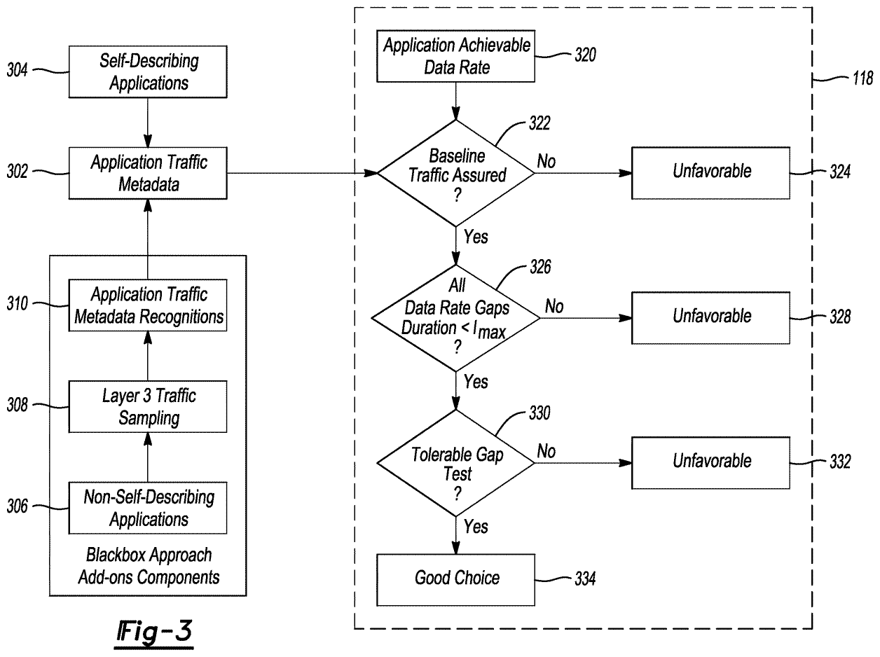

Refer now additionally to FIG. 3. There, a high-level outline of the principle of a communication option decision process 118 is illustrated. Communication option decision process 118 may be performed for multiple communication options, such as 4G LTE and 5G and, within 5G, sub-6 and mmWave.

In FIG. 3, application traffic metadata 302 may be gathered from self-describing communication applications 304 and non-self-describing communication applications 306.

The metadata from self-describing communication applications 304 may include whether the applications use constant bitrate (“CBR”) traffic. The metadata from self-describing communication applications 304 may include, if the applications use variable bitrate (“VBR”) traffic, the distribution of application bitrate. The CBR or VBR may be profile specific. The metadata may also include required bandwidth for minimum acceptable functionality of the application. The metadata may also include maximum allowable latency, beyond which the application times out network connections and tries to recreate the connection. Such metadata may provide intelligence about the nature of data communications in which self-describing communication applications 304 are and will be engaged.

The metadata from non-self-describing communication applications 306 may be gathered by sampling “Layer 3 Traffic” (block 308). Layer 3 traffic may include Transmission Control Protocol/Internet Protocol (“TCP/IP”) layer data. This application traffic metadata available from non-describing communication applications 306 may not be as detailed as the metadata available from self-describing communication applications 304. At block 310, application traffic metadata recognitions is performed; the metadata here predominantly includes the volume of data traffic.

At block 320, the available/achievable data rate is retrieved; as discussed, this may be via a data rate “heat map” and the planned driving route 112 of vehicle 106. When selecting a communication option for TCU 108, it is next determined whether a proposed communication option can carry “baseline” data traffic. “Baseline” data traffic may be considered minimum data traffic for the telecommunications system to be considered sufficiently functional. One example of baseline data traffic may be the voice data in a videoconferencing system, as distinguished from video data. Another example of baseline data traffic may be the reporting by a vehicle of anonymized location data. Baseline data traffic in this case may be textual data, while other vehicle data reporting may require significantly higher bandwidth, e.g., crowdsourcing vehicle camera data. Yet another example of baseline data traffic may be, in the case of cloud gaming, the lowest video resolution supported by a cloud-gaming platform as well as the bandwidth needed for user control from the user equipment to the cloud. At block 322, it is therefore determined whether sufficient data rate for average baseline application data traffic is assured. If such data rate is not assured by a given communication option, that communication option may be viewed as unfavorable and may be avoided (block 324).

If baseline application data traffic is assured by a given communication option, it may then considered at block 326 whether data rate gaps that might occur in use of that communication option will be less than a tolerable latency time lₘₐₓ. If NO, then that telecommunication option may be considered unfavorable and may be avoided (block 328). If YES, then at block 330 may is determined via a “gap test” whether data rate shortfalls that may occur through the use of that communication option may be recovered within lₘₐₓ. If NO, that communication option may be considered unfavorable and may be avoided (block 332). If YES, that communication option may be considered a good choice (block 334).

Refer now to FIG. 4. Among the curves illustrated there is curve 202, the achievable/available data rate (see also FIG. 2). Data being communicated may include baseline traffic 402, which may have an average 404. The data traffic may also include delay-tolerant traffic 406, which may have an average 408. (Of course, both baseline and delay-tolerant traffic are to be communicated via the telecommunications system. The two are shown separately in FIG. 4 and other graphs in this disclosure for clarity.) Focus now in particular on locations labelled “a” and “b” in FIG. 4. For the driving locations from point “a” to point “b”, achievable data rate curve 202 is below the level of delay-tolerant traffic 406. Thus, the achievable data rate during that duration is not sufficient to meet the data rate requirement. However, the communication option that generates the achievable data rate curve 202 may still be sufficient.

First, the communication option may be considered a reasonable candidate as long as the communication option will deliver, at a minimum, baseline traffic 402 of the system. If the communication option will not deliver at least that minimum amount of traffic, then the communication option may be considered unfavorable. This inquiry may be an example of the inquiry illustrated at block 322 (FIG. 3).

Next, the communication option may be sufficient as long as the communication option will continually or substantially continually prevent excessive data latency. That may be assessed by comparing the time between a and b (“time(a,b)”), a time gap during which achievable data rate curve 202 is below curve 408, to the maximum permissible latency lₘₐₓ. If time(a,b) is greater than lₘₐₓ, then the communication option in question may be considered unfavorable. This inquiry may be an example of the inquiry illustrated at block 326 (FIG. 3).

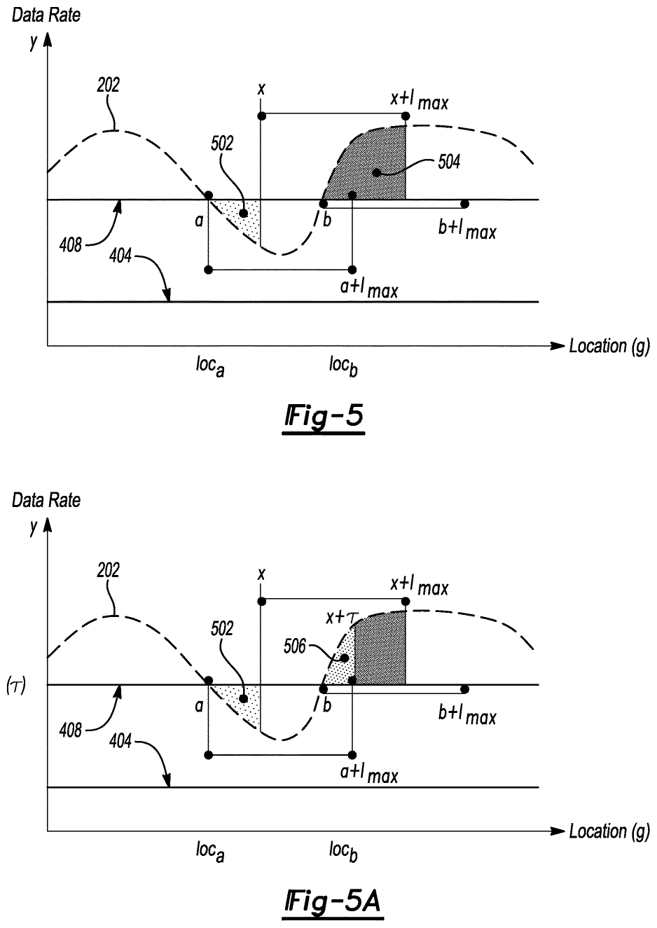

With additional reference to FIG. 5, it may now be considered whether a “gap test” will show that all or substantially all of the data rate deficits that occur when achievable data rate curve 202 falls below the level of delay tolerant traffic 406 can be recovered in a timely manner. There, for each location x between a and b, the following test may be performed:

$$Δ ( x ) = {\int }_{{t}_{a}}^{{t}_{x}} {\int }_{a}^{x} B ( t ) dgdt - {\int }_{{t}_{b}}^{{t}_{x + {l}_{max}}} {\int }_{b}^{x + {l}_{max}} B ( t ) dgdt ,$$

where
   A(x) is the difference between the surplus area 504 and the deficit area 502, and
      B(t) is the achievable data rate curve 202
         In this “gap test”, a double integral is employed because integration occurs both respect to distance of travel of vehicle 106 as well as with respect to time. If this “gap test” shows Δx>0 for each location x between a and b, it may be concluded that accumulated data communication deficits that accumulate between a and b may be timely recovered after b, when achievable data rate curve 202 rises above delay tolerant traffic curve 406. In that case, the communication option in question may be considered a good candidate for use by the telecommunications system. This gap test may be an example of the inquiry illustrated at block 330 (FIG. 3).

This “gap test” may be performed for each “x” between points “a” and “b”. If for each “x”, any data throughput deficit is compensated for by x+lₘₐₓ, then the communication option (5G or 4G LTE, or which base station within 5G or 4G LTE will be employed) that produced that result is a viable communication option to select for the upcoming travel of vehicle 106 from points “a” to “b”.

Refer now to FIG. 5A. The “gap test” referred to above may be performed with respect to each communication option available. This may demonstrate that multiple communication options may be viable; that is, multiple communications options may acceptably compensate for a transient deficit in data throughput. In that case, the one that fills the projected deficit or deficits in the shortest time may be selected as the communication option to be employed; that may produce lower latency, even though the other communication options may produce acceptable latency. The time in which the latency is made up by a particular communication option may be referred to as τ. In FIG. 5A, data rate deficiency illustrated by region 502 may actually have been compensated for by time x+τ, though it would be “acceptable” for that latency to have been compensated for by x+lₘₐₓ. A communication option that provides for a smaller value of t may be selected, in order to provide lower latency.

With non-self-describing applications, passive sampling of communications traffic may be used to characterize the nature of that traffic. The following table illustrates an example of the output of such sampling:

| Local IP | Local | Traffic | Payload | |
|---|---|---|---|---|
| Address | Port | Direction | Size | Timestamp |
| 192.168.0.3 | 8029 | Outgoing | 80 | 1712847486 |
| 192.168.0.3 | 9000 | Incoming | 1024 | 1712847486 |

“Payload size” may refer to the size of the sampled data packet, and “Timestamp” may refer to as the system time marker for when the data packet was sampled.

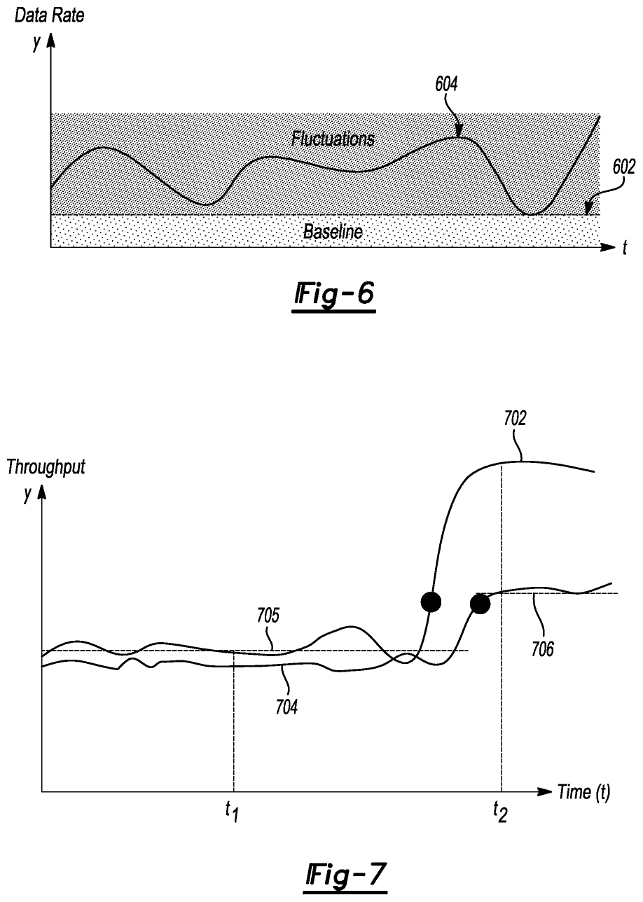

Refer now additionally to FIG. 6, an example of sampled data traffic. The traffic may include baseline traffic 602 and fluctuations 604 above the baseline traffic 602.

Refer now additionally to FIG. 7. The graph there reflects data throughput on the y-axis and time on the x-axis. Illustrated there is a curve reflecting achievable data rate 702. This may be similar to the achievable data rate curve 202 of FIG. 4 and may be derived similarly. Achievable data rate 702 may be derived from the planned driving route of vehicle 106 and the heat map showing achievable data rate as a function of position of vehicle 106. Achievable data rate curve provides a “look ahead” at the achievable data rate in the upcoming future for TCU 108 and therefore provides the ability to plan in advance the operational profiles of applications, in order to take advantage of improvements in achievable data rate.

At time t₁, application data traffic 704 and achievable data rate 702 are comparable, as illustrated in FIG. 7. Furthermore, application data traffic 704 is relatively steady over time. Thus, dashed line 705 may reflect a possible baseline for a relatively lower data rate profile for the applications in the telecommunication system.

Applications may work in different modes. The application data traffic characteristics for each mode can be treated as a profile. For instance, a streaming video application such as YouTube may stream videos at 4K, 480p, and other resolutions. Each mode requires quite different support in terms of network speed. In video conferencing, users may only turn on their microphone, or both microphone, camera, or even share their screen. Each enabled functionality means the application consumes network resources differently. This also applies to how much data users are willing to receive. For example, in vehicle video conferencing usually have screensharing disabled in the infotainment system to avoid driver distraction. In gaming, some games organize the game contents into playable and optimal. Playable means the basic contents are downloaded or ‘loaded’ via cellular connection, though some contents are missing, users are still able to play. In this case, continuous downloading may happen in the background with slower download speed. This can be treated as a different profile, compared to full speed download for optimal gaming experience, or gameplay when all contents are downloaded.

It may then be observed that when achievable data rate 702 increases at about time t₂, application traffic 704 increases as well and then may stabilize. The level at which application traffic 704 stabilized after t₂ may be the baseline of a higher data rate profile. Identifying multiple profiles and their presumed baselines may be useful in selection of a telecommunication option for TCU 108 of vehicle 106. Accordingly, a higher-profile data communications baseline 706 may be employed; this will allow improved use of better available data rate.

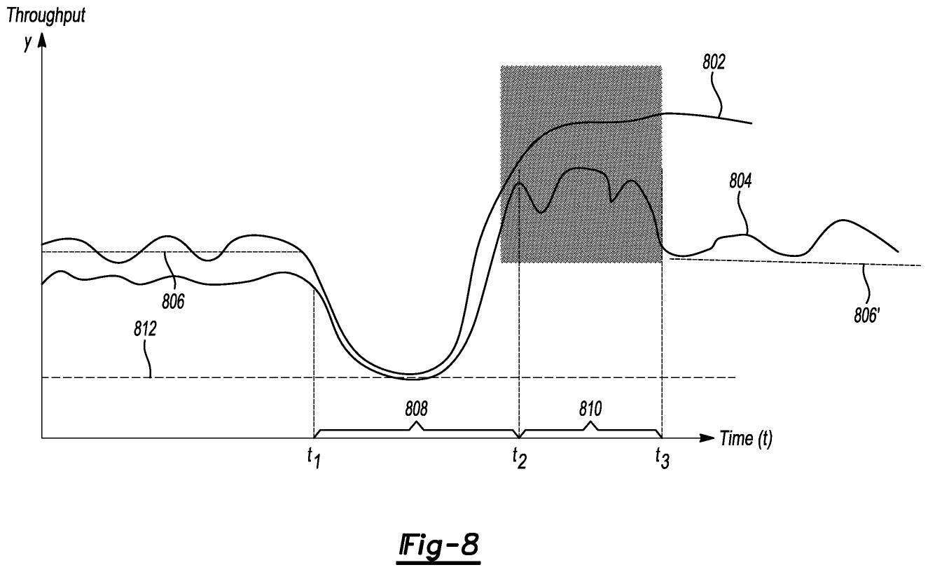

Refer now additionally to FIG. 8. The graph there again reflects data throughput on the y-axis and time on the x-axis. Illustrated there is curve representing achievable data rate 802, which may be viewed to be akin to the curve that reflects achievable data rate 702 (FIG. 7). Also illustrated in FIG. 8 is application traffic 804. Prior to time t₁, during which time a profile 806 has been in place, application traffic 804 is contained within achievable data rate 802. It may be recognized, however, that beginning at t₁, achievable data rate 802 may dip. Certainly, then, application traffic 804 will dip then as well, given the limitation in achievable data rate 802. However, it may also be recognized that when achievable data rate 802 increases beginning at time t₂, application traffic 804 may rise with it and “catch up” during time interval 810 relative to data transmission deficit that may occur between time t₁ and time t₂. Application traffic 804 may then at t₃ resume generally its state before t₁, settling at profile 806′ (which may be the same as profile 806). Given that sequence of events, it may be presumed that the time from t₁ to t₂, namely, time interval 808, may be an allowable latency of data communications occurring in the telecommunications system. Without knowing more, it is not clear at this point whether time interval 808 is the maximum allowable latency lₘₐₓ. Further observations may identify other allowable latencies that are longer than time interval 808.

Continuing with reference to FIG. 8, if application traffic 804 recovers after the dip during interval 808, it may be presumed that dashed line 812 may be a baseline for data traffic for the particular profile in question, and dashed line 812 may be used as such. Further observation may indicate that there is a lower baseline than dashed line 812.

Knowing, then, profiles of the telecommunications system, a presumed data rate baseline and a presumed maximum allowable latency lₘₐₓ, a communication option may be selected which will provide that, at a minimum, baseline data traffic is assured and latencies are always less than lₘₐₓ.

It is apparent that with non-self-describing applications, sampling may be used to acquire at least a portion of the application traffic metadata communicated by user equipment 108 in vehicle 106. It is also apparent from this disclosure that at least a portion of the application traffic metadata may also be acquired from self-describing applications.

It should be appreciated that “maximum allowable latency,” “acceptable latency,” “permissible latency” and other similar terms may be used in this disclosure to refer to data communication latency above which the telecommunication system is not considered to be performing acceptably. The amount of such latency may be predetermined, such as by being provided by metadata from self-describing communication applications. The amount of such latency may also be learned, such as by using sampling of TCP/IP traffic in the case of non-self-describing communication applications, one example of which has been disclosed herein in connection with the description of FIG. 8.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

What is claimed is:

1. A telecommunications method comprising, through one or more controllers:
acquiring communication traffic metadata from one or more communication applications in a vehicle;
identifying an achievable communication data rate for a first wireless communication option along a projected driving route of the vehicle; and
if all of the following are true, using the first wireless communication option for communication with the one or more communication applications:
baseline communications traffic of the one or more communication applications will be supported by the first communication option;
all or substantially all data rate time gaps during which the achievable communication data rate will be less than a required communication data rate for the one or more communication applications will be less than a maximum latency time; and
all or substantially all data communication deficits during which the achievable communication data rate will be less than the required communication data rate will be recovered by use of the first communication option at or before the maximum latency time.

2. The method of claim 1, wherein the first wireless communication option comprises cellular telecommunications.

3. The method of claim 2, wherein the first wireless communication option comprises fifth generation (“5G”) cellular telecommunications.

4. The method of claim 1, further comprising performing a gap test, wherein for a plurality of locations along the projected driving route of the vehicle when the achievable communication data rate will be less than the required communication data rate, confirming that any accumulated data communication deficits will be recovered within the maximum latency time.

5. The method of claim 1, wherein at least one of the communication applications is self-describing.

6. The method of claim 1, wherein at least a portion of the communication traffic metadata is acquired from non-self-describing communication applications.

7. The method of claim 1, further comprising sampling data traffic with at least one of the communication applications to infer communication profiles, baseline traffic, and allowable latency for at least one of the communication applications.

8. The method of claim 1, wherein at least a portion of the communication traffic metadata is acquired by sampling TCP/IP layer communications traffic with at least one of the communication applications.

9. A telecommunications method comprising, through one or more controllers:
acquiring communication traffic metadata from one or more communication applications in a vehicle;
identifying a first achievable communication data rate for a first cellular communication option along a projected driving route of the vehicle;
identifying a second achievable communication data rate for a second cellular communication option along the projected driving route of the vehicle;
confirming that the first cellular communication option can support a baseline communications traffic of the one or more communication applications along the projected driving route;
confirming that the second cellular communication option can support the baseline communication traffic;
confirming that with use of the first cellular communication option, all or substantially all data rate time gaps during which the first achievable communication data rate will be less than a required communication data rate for the one or more communication applications will be less than a maximum latency time;
confirming that with use of the second cellular communication option, all or substantially all data rate time gaps during which the second achievable communication data rate will be less than the required communication data rate will be less than the maximum latency time;
confirming that with use of the first cellular communication option, all or substantially all first data communication deficits during which the first achievable communication data rate will be less than the required communication data rate will be recovered by use of the first communication option at or before the maximum latency time;
confirming that with use of the second cellular communication option, all or substantially all second data communication deficits during which the second achievable communication data rate will be less than the required communication data rate will be recovered by use of the second communication option at or before the maximum latency time; and
if by use of the first cellular communication option, all or substantially all of the first data communication deficits will be recovered more quickly than the second data communication deficits will be recovered by use of the second cellular communication option, using the first cellular communication option for communication by the communication applications.

10. The method of claim 9, wherein the first cellular communication option comprises 5G cellular telecommunications and the second cellular communication option comprises 4G LTE cellular telecommunications.

11. The method of claim 9, wherein the first cellular communication option and the second cellular communication option each comprise 5G cellular telecommunications.

12. The method of claim 9, wherein at least one of the communication applications is self-describing.

13. The method of claim 12, wherein the at least one communication application communicates using variable bitrate traffic and the at least one communication application provides information that characterizes the variable bitrate traffic.

14. The method of claim 9, wherein at least a portion of the communication traffic metadata is acquired from non-self-describing communication applications.

15. The method of claim 9, wherein at least a portion of the communication traffic metadata is acquired by sampling Transmission Control Protocol/Internet Protocol (“TCP/IP”) layer communications traffic with at least one of the communication applications.

16. A vehicle comprising a telecommunications controller, the telecommunications controller programmed with and operable to execute the following instructions:
acquire communication traffic metadata from one or more communication applications in the vehicle;
identify an achievable communication data rate for a first wireless communication option along a projected driving route of the vehicle; and
if all of the following are true, use the first wireless communication option for communication with the one or more communication applications:
baseline communications traffic of the one or more communication applications will be supported by the first communication option;
all or substantially all data rate time gaps during which the achievable communication data rate will be less than a required communication data rate for the one or more communication applications will be less than a maximum latency time; and
all or substantially all data communication deficits during which the achievable communication data rate will be less than the required communication data rate will be recovered by use of the first wireless communication option at or before the maximum latency time.

17. The vehicle of claim 16, wherein the first wireless communication option comprises cellular telecommunications.

18. The vehicle of claim 17, wherein the first wireless communication option comprises 5G cellular telecommunications.

19. The vehicle of claim 16, wherein at least one of the communication applications is self-describing.

20. The vehicle of claim 16, wherein at least a portion of the communication traffic metadata is acquired by sampling TCP/IP layer communication traffic with at least one of the communication applications.
